(19) United States
(12) Patent Application Publication
(10) Pub. No.: US 2014/0099080 A1
(43) Pub. Date: Apr. 10, 2014

(54) Creating An Abridged Presentation Of A Media Work

(71) Applicant: INTERNATIONAL BUSINESS MACHINES CORP, Armonk, NY (US)

(72) Inventors: Gary D. Cudak, Creedmoor, NC (US); Christopher J. Hardee, Raleigh, NC (US); Randall C. Humes, Raleigh, NC (US); Adam Roberts, Moncure, NC (US)

(73) Assignee: INTERNATIONAL BUSINESS MACHINES CORPORATION, Armonk, NY (US)

(21) Appl. No.: 13/648,336

(22) Filed: Oct. 10, 2012

(51) Int. Cl. H04N 5/93

(52) U.S. Cl. 386/278; 386/E05.028

(57) ABSTRACT

Creating an abridged presentation of a media work, including: identifying, by a media abridging module, a plurality of segments of the media work; determining, by the media abridging module, a viewing frequency value for each of the segments of the media work; and creating, by the media abridging module, an abridged version of the media work in dependence upon the viewing frequency value for each of the segments of the media work, wherein the abridged version of the media work includes only a subset of the segments of the media work.

### BACKGROUND OF THE INVENTION

1. Field of the Invention

The field of the invention is data processing, or, more specifically, methods, apparatus, and products for creating an abridged presentation of a media work.

2. Description of Related Art

Viewing media content such as videos is a common use of modern computing devices. Many times, such media content will include only portions which are popular or commonly viewed by an audience. Users frequently skip around on a streaming media clip to segments they are more interested in, particularly on re-visitation. Many subsequent viewers will repeat these patterns. Some bandwidth is therefore wasted in these scenarios by buffering portions which have a low probability of consumption.

### SUMMARY OF THE INVENTION

Methods, apparatus, and products for creating an abridged presentation of a media work, including: identifying, by a media abridging module, a plurality of segments of the media work; determining, by the media abridging module, a viewing frequency value for each of the segments of the media work; and creating, by the media abridging module, an abridged version of the media work in dependence upon the viewing frequency value for each of the segments of the media work, wherein the abridged version of the media work includes only a subset of the segments of the media work.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example computer useful in creating an abridged presentation of a media work according to embodiments of the present invention.

FIG. 2 sets forth a flow chart illustrating an example method for creating an abridged presentation of a media work according to embodiments of the present invention.

FIG. 3 sets forth a flow chart illustrating a further example method for creating an abridged presentation of a media work according to embodiments of the present invention.

FIG. 4 sets forth a flow chart illustrating a further example method for creating an abridged presentation of a media work according to embodiments of the present invention.

FIG. 5 sets forth a flow chart illustrating a further example method for creating an abridged presentation of a media work according to embodiments of the present invention.

### DETAILED DESCRIPTION OF EXAMPLE EMBODIMENTS

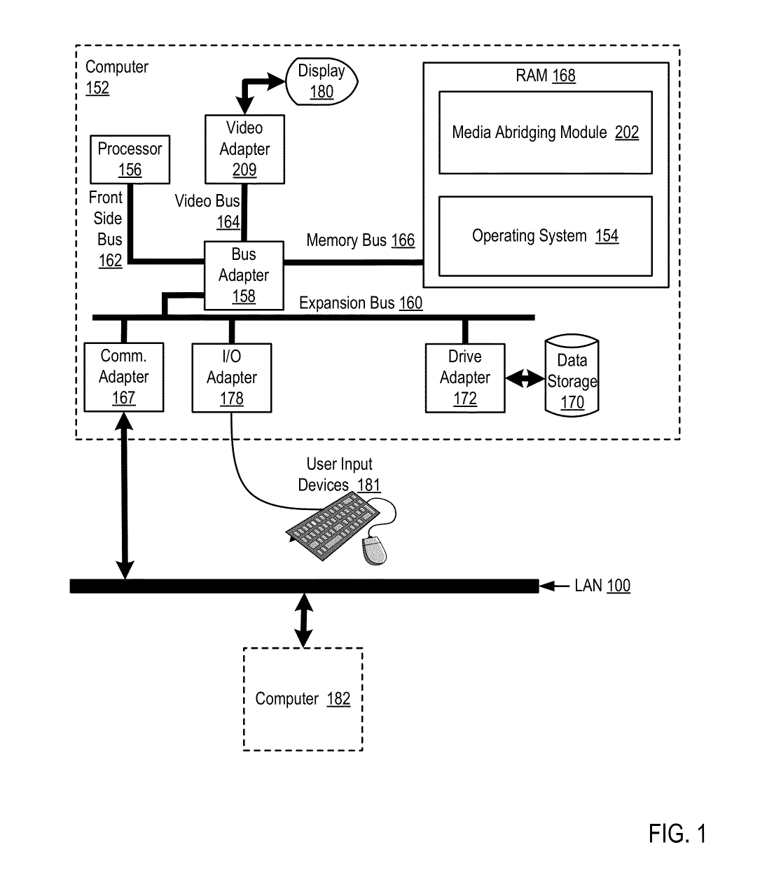

Example methods, apparatus, and products for creating an abridged presentation of a media work in accordance with the present invention are described with reference to the accompanying drawings, beginning with FIG. 1. FIG. 1 sets forth a block diagram of automated computing machinery comprising an example computer (152) useful in creating an abridged presentation of a media work according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a media abridging module (202), a module of computer program instructions for creating an abridged presentation of a media work according to embodiments of the present invention. The media work may be embodied, for example, as a view clip, audio-video file, streamed video content, and so on. The media abridging module (202) of FIG. 1 can carry out creating an abridged presentation of the media work by identifying a plurality of segments of the media work. Each segment represents a portion of the media work. Segments may be identified, for example, by dividing the media work into a predetermined number of segments, by dividing the media work into segments of a predetermined file size, by dividing the media work into segments of a predetermined duration of playback time, and so on. Consider an example in which the media work is a movie that has a playback time of two hours. Assume that the media work is to be divided into segments of a predetermined duration of run time of thirty seconds. In such an example, a first segment would include the first thirty seconds of the movie, a second segment would include the second thirty seconds of the movie, a third segment would include the third thirty seconds of the movie, and so on until 240 segments had been identified.

The media abridging module (202) of FIG. 1 can further carry out creating an abridged presentation of the media work by determining a viewing frequency value for each of the segments of the media work. The viewing frequency value for each of the segments of the media work represents the frequency at which each segment is actually watched by a viewer of the media work. Media works may be displayed through presentation devices such as a tablet computer, laptop computer, mobile communications device, personal computer, television, and many other devices as will occur to those of skill in the art. Such presentation devices will typically enable a viewer to fast forward through portions of the media work, skip over various portions of the media work, and control which portions of the media work are actually played. As such, some portions of a media work may be viewed more frequently than other portions. For example, if the media work is an episode of a television program that includes commercials, the commercials may be viewed less frequently than the other portions of the media work. As such, the viewing frequency value for a segment that includes commercials may be lower than the viewing frequency value for a segment that includes actual program content.

Determining a viewing frequency value for each of the segments of the media work may be carried out by tracking the behavior of a viewer when viewing the media work. The media abridging module (202) may be configured to receive information describing, for example, which portions of a media work were being played when a user began to fast forward through the media work, which portions of the media work were skipped over, which portions of the media work were not viewed prior to terminating the viewing session, which portions of the media work were viewed at a standard play speed, which portions of the media work were viewed multiple times through the use of a rewind feature, and so on. The media abridging module (202) may be configured to receive information from a content rendering application such as a video player for rendering audio-visual files such as Audio Video Interleaved (‘AVI’) files, Flash Video (‘FLV’) files, MP4 files, and so on. In some embodiments, the media abridging module may be a component of such a content rendering application.

Readers will appreciate that the behavior of many viewers may be tracked when viewing the media work. For example, if the media work is a video clip that is available through a video-sharing website, viewing statistics may be tracked for every user that views the media work. In such a way, statistics may be accumulated that identify which portions of a media work that viewers tend to watch more frequently and also to identify which portions of a media work that viewers tend to watch less frequently.

The media abridging module (202) of FIG. 1 can further carry out creating an abridged presentation of the media work by creating an abridged version of the media work. The abridged version of the media work is created in dependence upon the viewing frequency value for each of the segments of the media work. For example, the abridged version of the media work may include only a predetermined number of segments that have the highest viewing frequency value such that the abridged version of the media work includes only the most watched segments of the media work. The abridged version of the media work includes only a subset of the segments of the media work. Creating an abridged version of the media work may therefore be carried out by creating a media file in the same format as the media work and adding only those segments that have been identified for inclusion in the abridged version of the media work.

Consider the example described above in which the media work is a movie that has a play time of two hours. Assume that the media work is to be divided into segments of a predetermined duration of run time of thirty seconds. In such an example, 240 segments will be identified. Assume that an abridged version of the media work is to be created that is only three minutes in duration. In such an example, the media abridging module can therefore create an abridged version of the media work that includes the ten segments that have the highest viewing frequency value, thereby creating a three minute version of the media work that includes the most popular portions of the media work.

Also stored in RAM (168) is an operating system (154). Operating systems useful creating an abridged presentation of a media work according to embodiments of the present invention include UNIX™, Linux™, Microsoft XP™, AIX™, IBM's i5/OS™, and others as will occur to those of skill in the art. The operating system (154) and the media abridging module (202) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for creating an abridged presentation of a media work according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for creating an abridged presentation of a media work according to embodiments of the present invention include modems for wired dial-up communications, Ethernet (IEEE 802.3) adapters for wired data communications network communications, and 802.11 adapters for wireless data communications network communications.

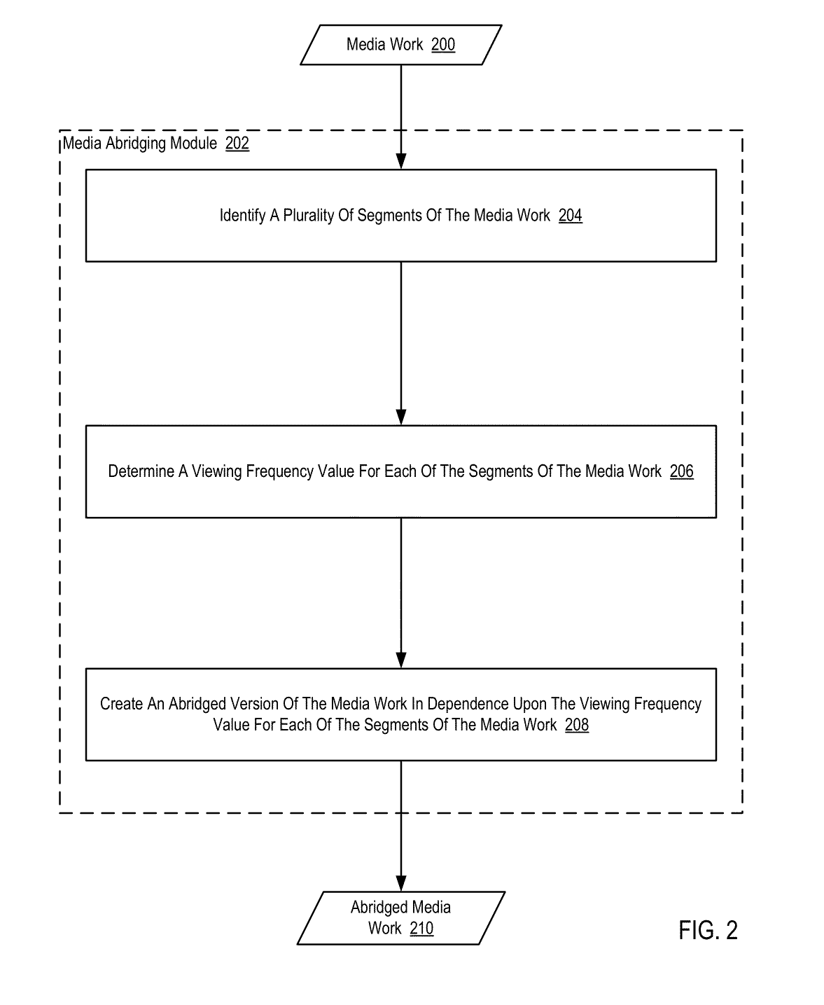

For further explanation, FIG. 2 sets forth a flow chart illustrating an example method for creating an abridged presentation of a media work (200) according to embodiments of the present invention. The media work (200) of FIG. 2 may be embodied, for example, as a view clip, audio-video file, streamed video content, and so on. The example method of FIG. 2 is carried out by a media abridging module (202). The media abridging module (202) may be embodied, for example, as a module of computer program instructions executing on computer hardware such as a computer processor.

The example method of FIG. 2 includes identifying (204), by the media abridging module (202), a plurality of segments of the media work (200). In the example method of FIG. 2, each segment represents a portion of the media work (200). Segments may be identified (204), for example, by dividing the media work (200) into a predetermined number of segments, by dividing the media work (200) into segments of a predetermined file size, by dividing the media work (200) into segments of a predetermined duration of run time, by dividing the media work (200) into segments of equal duration in time, and so on. Consider an example in which the media work (200) is a movie that has a play time of two hours. Assume that the media work (200) is to be divided into segments of a predetermined duration of run time of thirty seconds. In such an example, a first segment would include the first thirty seconds of the movie, a second segment would include the second thirty seconds of the movie, a third segment would include the third thirty seconds of the movie, and so on until 240 segments had been identified (204).

The example method of FIG. 2 also includes determining (206), by the media abridging module (202), a viewing frequency value for each of the segments of the media work (200). In the example method of FIG. 2, the viewing frequency value for each of the segments of the media work (200) represents the frequency at which each segment is actually watched by a viewer of the media work (200). Media works (200) may be displayed through presentation devices such as a tablet computer, laptop computer, mobile communications device, personal computer, television, and many other devices as will occur to those of skill in the art. Such presentation devices will typically enable a viewer to fast forward through portions of the media work (200), skip over various portions of the media work (200), and control which portions of the media work (200) are actually played. As such, some portions of a media work (200) may be viewed more frequently than other portions. For example, if the media work is an episode of a television program that includes commercials, the commercials may be viewed less frequently than the other portions of the media work (200). As such, the viewing frequency value for a segment that includes commercials may be lower than the viewing frequency value for a segment that includes actual program content.

In the example method of FIG. 2, determining (206) a viewing frequency value for each of the segments of the media work (200) may be carried out by tracking the behavior of a viewer when viewing the media work (200). The media abridging module (202) may be configured to receive information describing, for example, which portions of a media work (200) were being played when a user began to fast forward through the media work (200), which portions of the media work (200) were skipped over, which portions of the media work (200) were not viewed prior to terminating the viewing session, which portions of the media work (200) were viewed at a standard play speed, which portions of the media work (200) were viewed multiple times through the use of a rewind feature, and so on. In the example method of FIG. 2, media abridging module (202) may be configured to receive information from a content rendering application such as a video player for rendering audio-visual files such as AVI files, FLV files, MP4 files, and so on. In some embodiments, the media abridging module (202) may be a component of such a content rendering application.

Readers will appreciate that the behavior of many viewers may be tracked when viewing the media work (200). For example, if the media work (200) is a video clip that is available through a video-sharing website, viewing statistics may be tracked for every user that views the media work (200). In such a way, statistics may be accumulated that identify which portions of a media work (200) that viewers tend to watch more frequently and also to identify which portions of a media work (200) that viewers tend to watch less frequently.

The example method of FIG. 2 also includes creating (208), by the media abridging module (202), an abridged (210) version of the media work (200). In the example method of FIG. 2, the abridged (210) version of the media work (200) is created (208) in dependence upon the viewing frequency value for each of the segments of the media work (200). For example, the abridged (210) version of the media work (200) may include only a predetermined number of segments that have the highest viewing frequency value such that the abridged (210) version of the media work (200) includes only the most watched segments of the media work (200). In the example method of FIG. 2, the abridged (210) version of the media work (200) includes only a subset of the segments of the media work (200). Creating (208) an abridged (210) version of the media work (200) may therefore be carried out by creating a media file in the same format as the media work (200) and adding only those segments that have been identified for inclusion in the abridged (210) version of the media work (200).

Consider the example described above in which the media work (200) is a movie that has a play time of two hours. Assume that the media work (200) is to be divided into segments of a predetermined duration of run time of thirty seconds. In such an example, 240 segments will be identified (204). Assume that the abridged (210) version of the media work (200) is to be created (208) that is only three minutes in duration. In such an example, the media abridging module (202) can therefore create (208) an abridged (210) version of the media work (200) that includes the ten segments that have the highest viewing frequency value, thereby creating a three minute version of the media work (200) that includes the most popular portions of the media work.

Readers will appreciate that although the method of claim is illustrated to include one iteration of the steps described above, many iterations may take place such that the process of creating an abridged presentation of a media work (200) may be carried out many times. In such a way, the abridged presentation of the media work (200) may be modified and altered as the viewing habits of additional users are taken into an account. That is, the abridged presentation of a media work (200) may change over time as additional information is learned to better identify the portions of the media work (200) that are of interest to viewers.

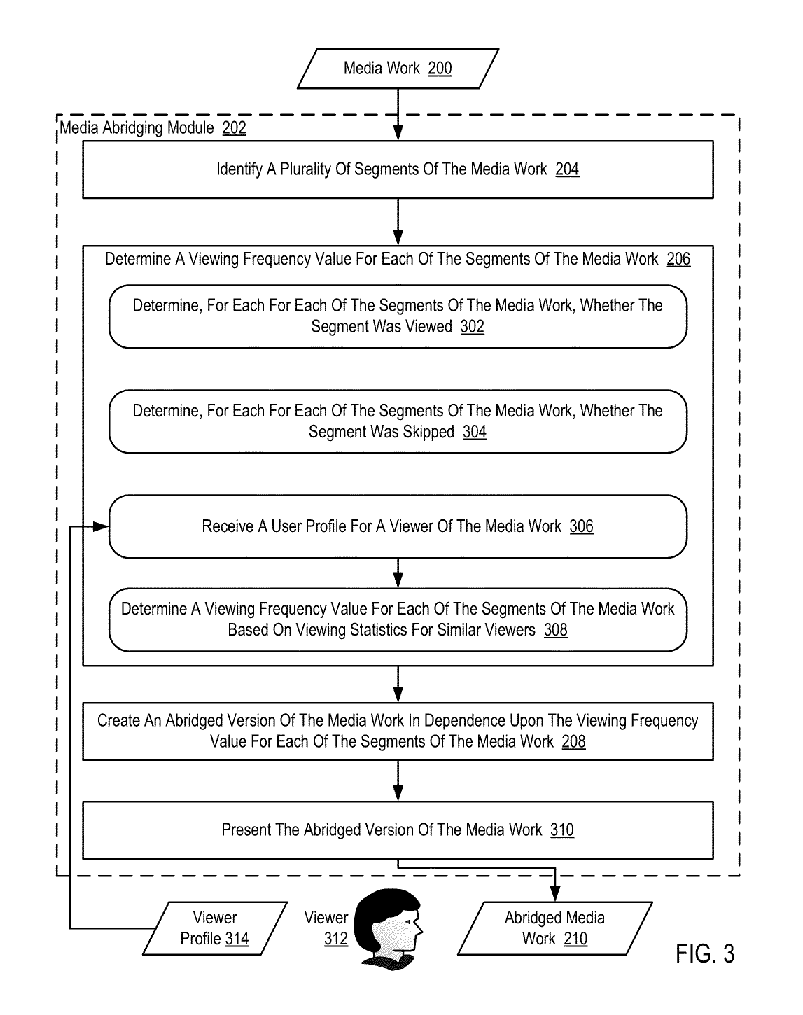

For further explanation, FIG. 3 sets forth a flow chart illustrating a further example method for creating an abridged presentation of a media work (200) according to embodiments of the present invention. The example method of FIG. 3 is similar to the example method of FIG. 2 as it also includes identifying (204) a plurality of segments of the media work (200), determining (206) a viewing frequency value for each of the segments of the media work (200), and creating (208) an abridged (210) version of the media work (200).

In the example method of FIG. 3, each segment of the media work (200) may be of a predetermined size. A predetermined size, as the phrase is used here, can represent a particular number of bytes of a data, a predetermined run time length when viewing a segment, and so on. The size may be predetermined in the sense that the size of a segment may be specified by a user, a system administrator, and so on. Alternatively, the particular predetermined size of a segment may be set to some default value specified in a system configuration.

In the example method of FIG. 3, determining (206) a viewing frequency value for each of the segments of the media work (200) can include determining (302), for each for each of the segments of the media work (200), whether the segment was viewed. In the example method of FIG. 3, determining (302) whether a particular segment of the media work (200) was viewed can be carried out, for example, based on the operation of a content rendering application such as a video player that is rendering the media work (200). For example, if the content rendering application is operating in playback mode when a particular segment is being rendered, it may be determined (302) that the segment was viewed. Alternatively, if the content rendering application is operating in fast forward mode when a particular segment is being rendered, it may be determined (302) that the segment was not viewed.

In the example method of FIG. 3, determining (206) a viewing frequency value for each of the segments of the media work (200) can alternatively include determining (304), for each for each of the segments of the media work (200), whether the segment was skipped. In the example method of FIG. 3, determining (304) whether a particular segment of the media work (200) was skipped can be carried out, for example, based on the operation of a content rendering application such as a video player that is rendering the media work (200). For example, if the content rendering application is operating in fast forward mode when a particular segment is being rendered, it may be determined (304) that the particular segment was skipped. Likewise, if a seek function that allows a viewer to jump to a particular portion of the media work (200) was invoked, all segments that reside between the point at which a seek operation was initiated and playback resumed may be determined (304) to have been skipped. For example, if a user initiates a seek operation at the two minute mark of a movie and regular playback operations resume at the ten minute mark of the movie, all segments between the two minute mark of the movie and the ten minute mark of the movie are determined (304) to have been skipped. Alternatively, if the content rendering application is operating in playback mode when a particular segment is being rendered, it may be determined (304) that the segment was not skipped.

In the example method of FIG. 3, determining (206) a viewing frequency value for each of the segments of the media work (200) can include receiving (306), by the media abridging module (202), a viewer profile (314) for a viewer (312) of the media work (200). In the example method of FIG. 3, the viewer profile (314) for a viewer (312) may be embodied as a data structure that includes information describing the viewer (312), including the viewer's viewing habits. The viewer profile (314) for a viewer (312) may include demographic information for the viewer (312) including, for example, the viewer's age, the viewer's gender, the viewer's education level, the viewer's location, and so on. The viewer profile (314) for a viewer (312) may also include information describing the viewer's viewing habits such as, for example, types of content that the viewer has watched in the past, genres of content that the viewer has expressed an interest in, ratings that the viewer has given to various media works, and so on.

In the example method of FIG. 3, determining (206) a viewing frequency value for each of the segments of the media work (200) can also include determining (308), by the media abridging module (202), a viewing frequency value for each of the segments of the media work (200) based on viewing statistics for similar viewers. In the example method of FIG. 3, similar viewers may be identified based on comparing the viewer profile (314) of the viewer (312) to viewer profiles for other viewers of the media work (200). Consider an example in which the viewer profile (314) for the viewer (312) indicates that the viewer is a thirty year-old male who has indicated a preference for comedic media content. In such an example, similar viewers may include other males that are the same age within a predetermined threshold whose profiles also indicate that they prefer comedic media content. In such an example, because the other viewers of the media work (200) are similar to the viewer (312) of FIG. 3, the viewing statistics of those similar viewers may be more relevant than the viewing statistics of dissimilar viewers when creating (208) abridged (210) version of the media work (200) for the viewer (312). As such, when determining (206) a viewing frequency value for each of the segments of the media work (200), the example method of FIG. 3 can make such a determination based on viewing statistics for similar viewers, while ignoring the viewing statistics for dissimilar viewers.

The example method of FIG. 3 also includes presenting (310), by the media abridging module (202), the abridged (210) version of the media work (200). In the example method of FIG. 3, the media abridging module (202) may include video rendering capabilities such that the media abridging module (202) can present (310) the abridged (210) version of the media work (200) for viewing by a viewer (312). In alternative embodiments, the abridged (210) version of the media work (200) may simply be created (208) by the media abridging module (202) for presentation through a separate application such as a video-playing application.

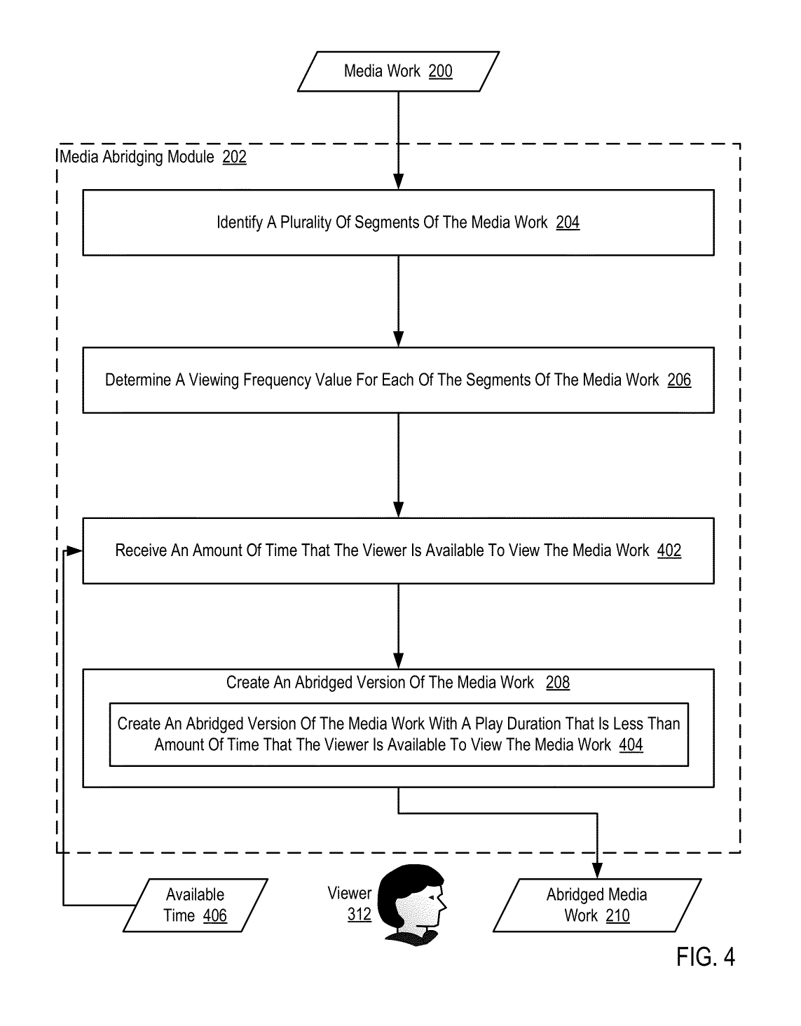

For further explanation, FIG. 4 sets forth a flow chart illustrating a further example method for creating an abridged presentation of a media work (200) according to embodiments of the present invention. The example method of FIG. 4 is similar to the example method of FIG. 2 as it also includes identifying (204) a plurality of segments of the media work (200), determining (206) a viewing frequency value for each of the segments of the media work (200), and creating (208) an abridged (210) version of the media work (200).

The example method of FIG. 4 also includes receiving (402), by the media abridging module (202) from a viewer (312) of the media work (200), an amount of time (406) that the viewer (312) is available to view the media work (200). In the example method of FIG. 4, the amount of time (406) that the viewer (312) is available to view the media work (200) may be received (402), for example, through the use of a graphical user interface presented to the viewer (312) through which the viewer can enter the amount of time (406) that the viewer (312) is available to view the media work (200).

In the example method of FIG. 4, creating (208) an abridged (210) version of the media work (200) can include creating (404) an abridged (210) version of the media work (200) with a play duration that is less than amount of time (406) that the viewer (312) is available to view the media work (200). Consider the example described above in which the media work (200) is a movie that has a play time of two hours. Assume that the media work (200) is to be divided into segments of a predetermined duration of run time of thirty seconds. In such an example, 240 segments will be identified (204). Further assume that the viewer (312) has indicated that the amount of time (406) that the viewer (312) is available to view the media work (200) is ten minutes. In such an example, the media abridging module (202) can therefore create (208) an abridged (210) version of the media work (200) that includes the twenty segments that have the highest viewing frequency value, thereby creating a ten minute version of the media work (200) that includes the most popular portions of the media work.

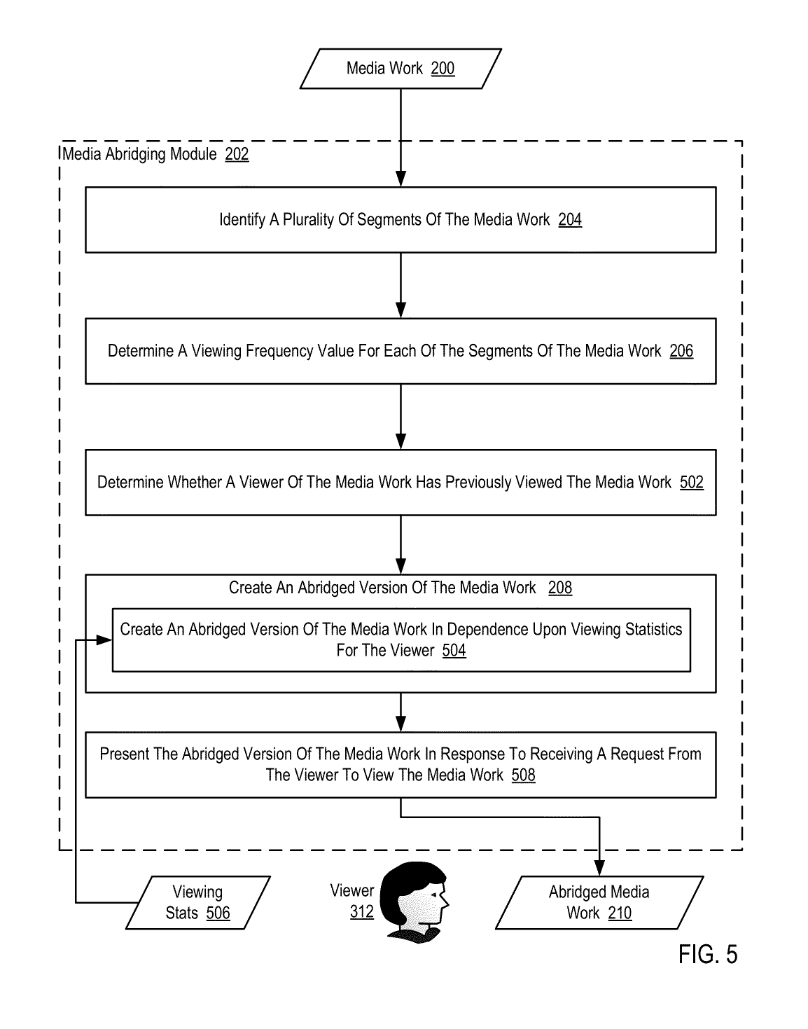

For further explanation, FIG. 5 sets forth a flow chart illustrating a further example method for creating an abridged presentation of a media work (200) according to embodiments of the present invention. The example method of FIG. 5 is similar to the example method of FIG. 2 as it also includes identifying (204) a plurality of segments of the media work (200), determining (206) a viewing frequency value for each of the segments of the media work (200), and creating (208) an abridged (210) version of the media work (200).

The example method of FIG. 5 also includes determining (502), by the media abridging module (202), whether a viewer (312) of the media work (200) has previously viewed the media work (200). In the example method of FIG. 5, determining (502) whether a viewer (312) of the media work (200) has previously viewed the media work (200) may be carried out, for example, by searching a playlist associated with the viewer (312) that identifies all media works previously viewed by the viewer (312). In such an example, each time a viewer (312) consumes some media work, the media work may be added to a playlist associated with the viewer (312).

The example method of FIG. 5 also includes creating (504) an abridged (210) version of the media work (200) in dependence upon viewing statistics for the viewer (312). In the example method of FIG. 5, creating (504) an abridged (210) version of the media work (200) in dependence upon viewing statistics for the viewer (312) is carried out in response to determining that the viewer (312) of the media work (200) has previously viewed the media work (200). In the example method of FIG. 5, the viewing statistics for the viewer (312) can include information identifying the portions of the media work (200) that were watched when the viewer (312) previously viewed the media work (200), information identifying the portions of the media work (200) that were not watched when the viewer (312) previously viewed the media work (200), and so on. In such an example, the abridged (210) version of the media work (200) can be created (504) in dependence upon the viewing statistics for the viewer (312) such that the abridged (210) version of the media work (200) includes those portions of the media work (200) that are of interest to the viewer (312), as evidenced by the viewer's (312) previous consumption of the media work (200).

The example method of FIG. 5 also includes presenting (508), by the media abridging module (202), the abridged (210) version of the media work (200) in response to receiving a request from the viewer (312) to view the media work (200). Consider an example in which the media work (200) is a video clip from a shared video website. When the viewer (312) makes a request to view the video clip, for example, by clicking on a hyperlink to initiate playing the media work (200), the media abridging module (202) may present the viewer (312) with an abridged (210) version of the media work (200) rather than presenting the user with the full version of the media work (200). Alternatively, when the viewer (312) makes a request to view the video clip by clicking on a hyperlink to initiate playing the media work (200), the media abridging module (202) may present the viewer (312) with an option to view an abridged (210) version of the media work (200). In such a way, the abridged (210) version of the media work (200) may be presented (508) to the viewer (312) in response to receiving a request from the viewer (312) to view the media work (200).

Example embodiments of the present invention are described largely in the context of a fully functional computer system for creating an abridged presentation of a media work. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the example embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1-9. (canceled)

10. An apparatus for creating an abridged presentation of a media work, the apparatus comprising a computer processor, a computer memory operatively coupled to the computer processor, the computer memory having disposed within it computer program instructions that, when executed by the computer processor, cause the apparatus to carry out the steps of:
identifying, by a media abridging module, a plurality of segments of the media work;
determining, by the media abridging module, a viewing frequency value for each of the segments of the media work; and
creating, by the media abridging module, an abridged version of the media work in dependence upon the viewing frequency value for each of the segments of the media work, wherein the abridged version of the media work includes only a subset of the segments of the media work.

11. The apparatus of claim 10 further comprising computer program instructions that, when executed by the computer processor, cause the apparatus to carry out the step of presenting, by the media abridging module, the abridged version of the media work.

12. The apparatus of claim 10 wherein each segment of the media work has a predetermined size.

13. The apparatus of claim 10 wherein determining, by the media abridging module, a viewing frequency value for each of the segments of the media work further comprises determining, for each of the segments of the media work, whether the segment was viewed.

14. The apparatus of claim 10 wherein determining, by the media abridging module, a viewing frequency value for each of the segments of the media work further comprises determining, for each of the segments of the media work, whether the segment was skipped.

15. The apparatus of claim 10 wherein determining, by the media abridging module, a viewing frequency value for each of the segments of the media work further comprises:
receiving, by the media abridging module, a viewer profile for a viewer of the media work; and
determining, by the media abridging module, a viewing frequency value for each of the segments of the media work based on viewing statistics for similar viewers.

16. The apparatus of claim 10 further comprising computer program instructions that, when executed by the computer processor, cause the apparatus to carry out the step of:
receiving, by the media abridging module from a viewer of the media work, an amount of time that the viewer is available to view the media work; and
wherein creating, by the media abridging module, an abridged version of the media work includes creating an abridged version of the media work with a play duration that is less than the amount of time that the viewer is available to view the media work.

17. The apparatus of claim 10 further comprising computer program instructions that, when executed by the computer processor, cause the apparatus to carry out the steps of:
determining, by the media abridging module, whether a viewer of the media work has previously viewed the media work; and
responsive to determining that the viewer of the media work has previously viewed the media work, creating an abridged version of the media work in dependence upon viewing statistics for the viewer.

18. A computer program product for creating an abridged presentation of a media work, the computer program product disposed upon a computer readable medium, the computer program product comprising computer program instructions that, when executed, cause a computer to carry out the steps of:
identifying, by a media abridging module, a plurality of segments of the media work;
determining, by the media abridging module, a viewing frequency value for each of the segments of the media work; and
creating, by the media abridging module, an abridged version of the media work in dependence upon the viewing frequency value for each of the segments of the media work, wherein the abridged version of the media work includes only a subset of the segments of the media work.

19. The computer program product of claim 18 further comprising computer program instructions that, when executed, cause the computer to carry out the step of presenting, by the media abridging module, the abridged version of the media work.

20. The computer program product of claim 18 wherein each segment of the media work has a predetermined size.

21. The computer program product of claim 18 wherein determining, by the media abridging module, a viewing frequency value for each of the segments of the media work further comprises determining, for each of the segments of the media work, whether the segment was viewed.

22. The computer program product of claim 18 wherein determining, by the media abridging module, a viewing frequency value for each of the segments of the media work further comprises determining, for each of the segments of the media work, whether the segment was skipped.

23. The computer program product of claim 18 wherein determining, by the media abridging module, a viewing frequency value for each of the segments of the media work further comprises:
receiving, by the media abridging module, a viewer profile for a viewer of the media work; and
determining, by the media abridging module, a viewing frequency value for each of the segments of the media work based on viewing statistics for similar viewers.

24. The computer program product of claim 18 further comprising computer program instructions that, when executed, cause the computer to carry out the step of:
receiving, by the media abridging module from a viewer of the media work, an amount of time that the viewer is available to view the media work; and
wherein creating, by the media abridging module, an abridged version of the media work includes creating an abridged version of the media work with a play duration that is less than the amount of time that the viewer is available to view the media work.

25. The computer program product of claim 18 further comprising computer program instructions that, when executed, cause the computer to carry out the steps of:
determining, by the media abridging module, whether a viewer of the media work has previously viewed the media work; and
responsive to determining that the viewer of the media work has previously viewed the media work, creating an abridged version of the media work in dependence upon viewing statistics for the viewer.
